(19) United States
(12) Patent Application Publication
(10) Pub. No.: US 2015/0095597 A1
(43) Pub. Date: Apr. 2, 2015

(54) HIGH PERFORMANCE INTELLIGENT VIRTUAL DESKTOP INFRASTRUCTURE USING VOLATILE MEMORY ARRAYS

(71) Applicant: AMERICAN MEGATRENDS, INC., NORCROSS, GA (US)

(72) Inventors: Varadachari Sudan Ayanam, Suwanee, GA (US); Samvinesh Christopher, Suwanee, GA (US); Sanjoy Maity, Snellville, GA (US); Baskar Parthiban, Johns Creek, GA (US); Joseprabu Inbaraj, Suwanee, GA (US)

(73) Assignee: AMERICAN MEGATRENDS, INC., NORCROSS, GA (US)

(21) Appl. No.: 14/041,398

(22) Filed: Sep. 30, 2013

(51) Int. Cl. G06F 3/06; G06F 9/455

(52) U.S. Cl. CPC G06F 3/065; G06F 3/0604; G06F 3/0641; G06F 3/067; G06F 9/45533
USPC 711/162

(57) ABSTRACT

Certain aspects of the disclosure relate to a system and method for performing intelligent virtual desktop infrastructure (iVDI) using volatile memory arrays. The system has a hypervisor server and a storage server in communication via a file sharing protocol. A random access memory (RAM) disk is launched on a volatile memory array using a RAM disk driver. The RAM disk driver then assigns local and remote storages of the storage server as primary and secondary backup storages for the RAM disk. A group of virtual machine (VM) images is deployed to the RAM disk, and deduplication is performed on the VM images to release some memory space of the RAM disk. The deploying and deduplicating of the VM images continues repeatedly until the RAM disk is almost full. Then, the VM images in the RAM disk are copied to the backup storages as backup copies.

### FIELD

The present disclosure relates generally to virtual desktop infrastructure (VDI) technology, and particularly to high performance intelligent VDI (iVDI) using volatile memory arrays for storing virtual machine images.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Virtual desktop infrastructure (VDI) is a desktop-centric service that hosts user desktop environments on remote servers or personal computers, which are accessed over a network using a remote display protocol. Typically, VDI uses disk storage for storing the virtual machine (VM) images, user profiles, and other information for the end users to access. However, when simultaneous access of the VM's are needed, data access to the multiple VM images from the disk storage may be too slow. Particularly, the VDI service may be degraded when a significant number of end users boot up within a very narrow time frame and overwhelm the network with data requests (generally referred to as “bootstorm”). The occurrence of bootstorm creates a bottleneck for the VDI service.

Therefore, an unaddressed need exists in the art to address the aforementioned deficiencies and inadequacies.

### SUMMARY

Certain aspects of the present disclosure direct to a method for performing intelligent virtual desktop infrastructure (iVDI) using volatile memory arrays. In certain embodiments, the method includes: launching a random access memory (RAM) disk on a volatile memory array using a RAM disk driver; assigning a local storage physically located at a storage server as a primary backup storage for the RAM disk, wherein the storage server is connected to a hypervisor server via a file sharing protocol, and the hypervisor server is configured to execute a hypervisor; deploying a first plurality of virtual machine (VM) images to the RAM disk; deduplicating the first plurality of VM images in the RAM disk to release a first memory space of the RAM disk; deploying a second plurality of VM images to the RAM disk and to occupy at least a part of the first memory space; deduplicating the second plurality of VM images in the RAM disk; and copying the deduplicated first plurality of VM images and the deduplicated second plurality of VM images from the RAM disk to the primary backup storage.

In certain embodiments, the method further includes: launching, at the hypervisor server, the hypervisor.

In certain embodiments, the method further includes: in response to an accessing command for a requested VM image from a remote computing device connected to the hypervisor server via a network, sending a request for the requested VM image from the hypervisor server to the storage server; retrieving, at the storage server, the requested VM image from the RAM disk; sending the requested VM image from the storage server to the hypervisor server; and running, at the hypervisor server, the requested VM image on the hypervisor.

In certain embodiments, the method further includes: in response to a writing command of data to the running VM image, simultaneously writing the data to the running VM image at the RAM disk and at the primary backup storage.

In certain embodiments, the simultaneously writing of the data to the running VM image at the RAM disk and at the primary backup storage includes: receiving, by the hypervisor, the writing command; monitoring, by the RAM disk driver, the writing command; writing, by the hypervisor, the data to the running VM image at the RAM disk according to the writing command; and simultaneously writing, by the RAM disk driver, the data to the running VM image at the primary backup storage and at the secondary backup storage according to the writing command.

In certain embodiments, the file sharing protocol is a server message block (SMB) protocol.

In certain embodiments, the deduplicating of the first plurality of VM images and the deduplicating of the second plurality of VM images in the RAM disk are performed by a deduplication module. The deduplication module is configured to, when executed at a processor, compare the VM images to identify at least one repeat data chunk existing for multiple times in the VM images; store the at least one repeat data chunk in the RAM disk; store a reference in the VM image pointing to the at least one repeat data chunk stored in the RAM disk; and remove the at least one repeat data chunk for the VM images.

In certain embodiments, the deduplication module is configured to, when executed at a processor, identify a reference VM image from the VM images in the RAM disk; for each VM image, compare the VM image to the reference VM image to identify the at least one repeat data chunk existing in both the VM image and the reference VM image, and a unique data chunk existing only in the VM image; store a reference in the VM image pointing to the at least one repeat data chunk of the reference VM image; and remove the at least one repeat data chunk in the VM image.

In certain embodiments, the deduplication module is further configured to, when executed at a processor, periodically deduplicate the VM images stored in the RAM disk and the VM images stored in the primary backup storage.

In certain embodiments, the copying of the deduplicated VM images from the RAM disk to the primary backup storage is performed by a backup module.

In certain embodiments, the method further includes: assigning a remote storage device not located at the storage server as a secondary backup storage for the RAM disk; copying, by the backup module, the deduplicated VM images from the RAM disk to the secondary backup storage; in response to the RAM disk being relaunched and the primary backup storage being available, copying the VM images from the primary backup storage to the RAM disk; and in response to the RAM disk being relaunched and the primary backup storage being unavailable, copying the VM images from the secondary backup storage to the RAM disk.

In certain embodiments, the backup module is further configured to, when executed at a processor, periodically copying the VM images from the RAM disk to the primary backup storage and the secondary backup storage.

In certain embodiments, the RAM disk driver stores configuration settings of the RAM disk, and wherein the configuration settings of the RAM disk comprises a storage type of the RAM disk, partition type of the RAM disk, size of the RAM disk, and information of the assigned primary backup storage.

Certain aspects of the present disclosure direct to an intelligent virtual desktop infrastructure (iVDI) system. In certain embodiments, the system includes a hypervisor server configured to execute a hypervisor; a storage server in communication to the hypervisor server via a file sharing protocol, wherein the storage server comprises a local storage physically located at the storage server and a remote storage device not located at the storage server, wherein the storage server stores a random access memory (RAM) disk driver; and a volatile memory array, including volatile memory provided on at least one of the hypervisor server and the storage server. The RAM disk driver includes computer executable codes, wherein the codes, when executed on the hypervisor at a processor, are configured to: launch a RAM disk on the volatile memory array using the RAM disk driver; assign the local storage as a primary backup storage for the RAM disk, and the remote storage as a secondary backup storage for the RAM disk; deploy a first plurality of virtual machine (VM) images to the RAM disk; deduplicate the first plurality of VM images in the RAM disk to release a first memory space of the RAM disk; deploy a second plurality of VM images to the RAM disk and to occupy at least a part of the first memory space; deduplicate the second plurality of VM images in the RAM disk; and copy the deduplicated first plurality of VM images and the deduplicated second plurality of VM images from the RAM disk to the primary backup storage.

In certain embodiments, the file sharing protocol is a SMB protocol.

In certain embodiments, the system further includes at least one remote computing device in communication to the hypervisor server via a network. In response to an accessing command for a requested VM image from the remote computing device, the codes, when executed on the hypervisor at the processor, are further configured to: send a request for the requested VM image from the hypervisor server to the storage server; retrieve the requested VM image from the RAM disk; send the requested VM image from the storage server to the hypervisor server; and run the requested VM image on the hypervisor. In response to a writing command of data to the running VM image from the remote computing device, the codes, when executed on the hypervisor at the processor, are further configured to: receive the writing command; write the data to the running VM image at the RAM disk according to the writing command; and simultaneously write the data to the running VM image at the primary backup storage and at the secondary backup storage according to the writing command.

In certain embodiments, the codes include a deduplication module and a backup module. The deduplication module is configured to: compare the VM images to identify at least one repeat data chunk existing for multiple times in the VM images; store the at least one repeat data chunk in the RAM disk; store a reference in the VM image pointing to the at least one repeat data chunk stored in the RAM disk; and remove the at least one repeat data chunk for the VM images. The backup module is configured to: copy the deduplicated VM images from the RAM disk to the primary backup storage and the secondary backup storage; in response to the RAM disk being relaunched and the primary backup storage being available, copy the VM images from the primary backup storage to the RAM disk; and in response to the RAM disk being relaunched and the primary backup storage being unavailable, copy the VM images from the secondary backup storage to the RAM disk.

In certain embodiments, the deduplication module is further configured to periodically deduplicate the VM images stored in the RAM disk and the VM images stored in the primary backup storage.

In certain embodiments, the RAM disk driver further includes configuration settings of the RAM disk, and wherein the configuration settings of the RAM disk comprises a storage type of the RAM disk, partition type of the RAM disk, size of the RAM disk, and information of the assigned primary backup storage.

Certain aspects of the present disclosure directs to a non-transitory computer readable medium storing a RAM disk driver. The RAM disk driver includes computer executable codes. The codes, when executed at a processor, are configured to: launch a RAM disk on a volatile memory array using the RAM disk driver; assign a local storage of a storage server as a primary backup storage for the RAM disk, and a remote storage of the storage server as a secondary backup storage for the RAM disk, wherein the storage server is connected to a hypervisor server via a file sharing protocol, and the hypervisor server is configured to execute a hypervisor; deploy a first plurality of virtual machine (VM) images to the RAM disk; deduplicate the first plurality of VM images in the RAM disk to release a first memory space of the RAM disk; deploy a second plurality of VM images to the RAM disk and to occupy at least a part of the first memory space; deduplicate the second plurality of VM images in the RAM disk; and copy the deduplicated first plurality of VM images and the deduplicated second plurality of VM images from the RAM disk to the primary backup storage.

In certain embodiments, the file sharing protocol is a SMB protocol.

In certain embodiments, in response to an accessing command for a requested VM image from the remote computing device, the codes are configured to send a request for the requested VM image from the hypervisor server to the storage server; retrieve the requested VM image from the RAM disk; send the requested VM image from the storage server to the hypervisor server; and run the requested VM image on the hypervisor. In certain embodiments, in response to a writing command of data to the running VM image from the remote computing device, the codes are further configured to: receive the writing command; write the data to the running VM image at the RAM disk according to the writing command; and simultaneously write the data to the running VM image at the primary backup storage and at the secondary backup storage according to the writing command.

In certain embodiments, the codes include a deduplication module and a backup module. The deduplication module is configured to: compare the VM images to identify at least one repeat data chunk existing for multiple times in the VM images; store the at least one repeat data chunk in the RAM disk; store a reference in the VM image pointing to the at least one repeat data chunk stored in the RAM disk; and remove the at least one repeat data chunk for the VM images. The backup module is configured to: copy the deduplicated VM images from the RAM disk to the primary backup storage and the secondary backup storage; in response to the RAM disk being relaunched and the primary backup storage being available, copy the VM images from the primary backup storage to the RAM disk; and in response to the RAM disk being relaunched and the primary backup storage being unavailable, copy the VM images from the secondary backup storage to the RAM disk.

In certain embodiments, the deduplication module is further configured to periodically deduplicate the VM images stored in the RAM disk and the VM images stored in the primary backup storage.

In certain embodiments, the RAM disk driver further includes configuration settings of the RAM disk, and wherein the configuration settings of the RAM disk comprises a storage type of the RAM disk, partition type of the RAM disk, size of the RAM disk, and information of the assigned primary backup storage.

These and other aspects of the present disclosure will become apparent from the following description of the preferred embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the detailed description and the accompanying drawings, wherein:

FIG. 1 schematically depicts an iVDI system according to certain embodiments of the present disclosure;

FIG. 2A schematically depicts a hypervisor server of the system according to certain embodiments of the present disclosure;

FIG. 2B schematically depicts the execution of the VM's on the system according to certain embodiments of the present disclosure;

FIG. 3 schematically depicts a storage server according to certain embodiments of the present disclosure;

FIG. 4A schematically depicts the VM image data before deduplication according to certain embodiments of the present disclosure;

FIG. 4B schematically depicts the VM image data during deduplication according to certain embodiments of the present disclosure;

FIG. 4C schematically depicts the VM image data after deduplication according to certain embodiments of the present disclosure;

FIG. 5 depicts a flowchart of installing the system and deploying VM images according to certain embodiments of the present disclosure;

FIG. 6 depicts a flowchart of running a VM on the hypervisor according to certain embodiments of the present disclosure;

FIG. 7 depicts a flowchart of writing or changing data to a VM image according to certain embodiments of the present disclosure; and

FIG. 8 depicts a flowchart of restoring the VM image data in the RAM disk when the system restarts according to certain embodiments of the present disclosure.

### DETAILED DESCRIPTION

The present disclosure is more particularly described in the following examples that are intended as illustrative only since numerous modifications and variations therein will be apparent to those skilled in the art. Various embodiments of the disclosure are now described in detail. Referring to the drawings, like numbers, if any, indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present disclosure. Additionally, some terms used in this specification are more specifically defined below.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the disclosure or of any exemplified term. Likewise, the disclosure is not limited to various embodiments given in this specification.

Unless otherwise defined, all technical and scientific terms used herein have the same meaning as commonly understood by one of ordinary skill in the art to which this disclosure pertains. In the case of conflict, the present document, including definitions will control.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, “plurality” means two or more.

As used herein, the terms “comprising,” “including,” “carrying,” “having,” “containing,” “involving,” and the like are to be understood to be open-ended, i.e., to mean including but not limited to.

As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure.

As used herein, the term “module” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term “code”, as used herein, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

As used herein, the term “server” generally refers to a system that responds to requests across a computer network to provide, or help to provide, a network service. An implementation of the server may include software and suitable computer hardware. A server may run on a computing device or a network computer. In some cases, a computer may provide several services and have multiple servers running.

As used herein, the term “hypervisor” generally refers to a piece of computer software, firmware or hardware that creates and runs virtual machines. The hypervisor is sometimes referred to as a virtual machine manager (VMM).

As used herein, the term “headless system” or “headless machine” generally refers to the computer system or machine that has been configured to operate without a monitor (the missing “head”), keyboard, and mouse.

The term “interface”, as used herein, generally refers to a communication tool or means at a point of interaction between components for performing data communication between the components. Generally, an interface may be applicable at the level of both hardware and software, and may be uni-directional or bi-directional interface. Examples of physical hardware interface may include electrical connectors, buses, ports, cables, terminals, and other I/O devices or components. The components in communication with the interface may be, for example, multiple components or peripheral devices of a computer system.

The terms “chip” or “computer chip”, as used herein, generally refer to a hardware electronic component, and may refer to or include a small electronic circuit unit, also known as an integrated circuit (IC), or a combination of electronic circuits or ICs.

The present disclosure relates to computer systems. As depicted in the drawings, computer components may include physical hardware components, which are shown as solid line blocks, and virtual software components, which are shown as dashed line blocks. One of ordinary skill in the art would appreciate that, unless otherwise indicated, these computer components may be implemented in, but not limited to, the forms of software, firmware or hardware components, or a combination thereof.

The apparatuses and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

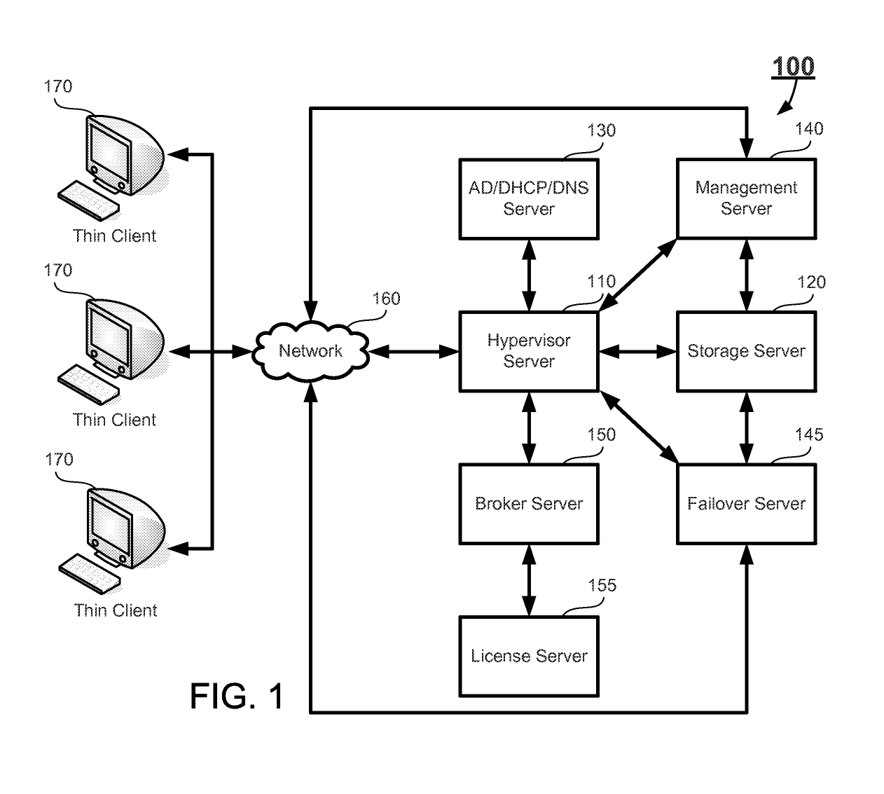

FIG. 1 schematically depicts an iVDI system according to certain embodiments of the present disclosure. As shown in FIG. 1, the system 100 includes a hypervisor server 110 and a storage server 120. In certain embodiments, the system 100 further includes an active directory (AD)/dynamic host configuration protocol (DHCP)/domain name system (DNS) server 130, a management server 140, a failover server 145, a broker server 150, and a license server 155. A plurality of thin client computers 170 is connected to the hypervisor server 110 via a network 160. The system 100 adopts the virtual desktop infrastructure, and can be a system that incorporates more than one interconnected system, such as a client-server network. The network 130 may be a wired or wireless network, and may be of various forms such as a local area network (LAN) or wide area network (WAN) including the Internet.

The hypervisor server 110 is a computing device serving as a host server for the system, providing a hypervisor for running VM instances. In certain embodiments, the hypervisor server 110 may be a general purpose computer server system or a headless server.

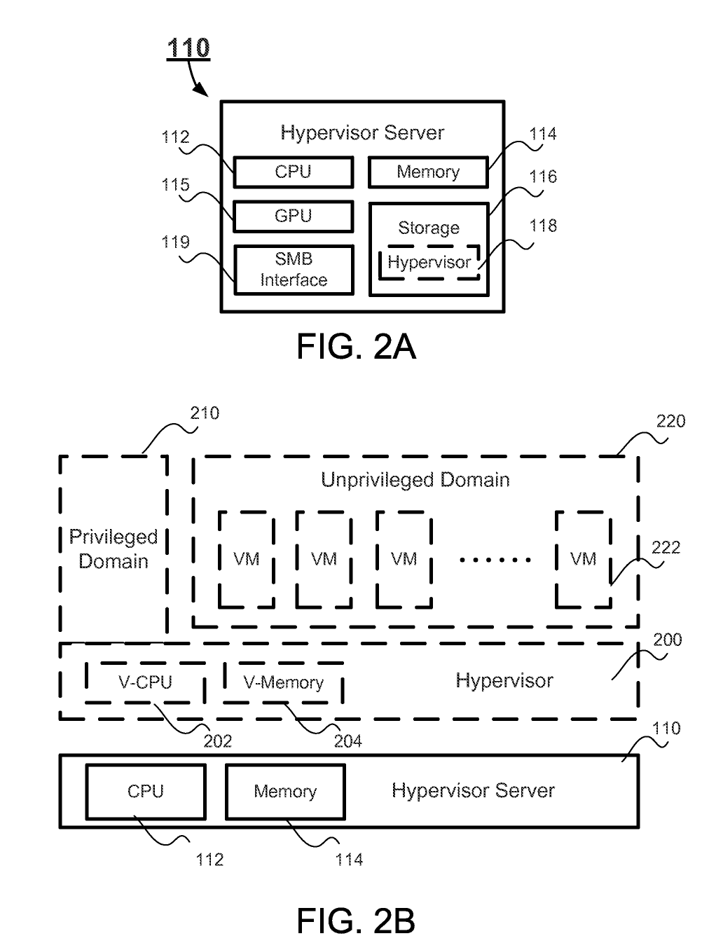

FIG. 2A schematically depicts a hypervisor server of the system according to certain embodiments of the present disclosure. As shown in FIG. 2A, the hypervisor server 110 includes a central processing unit (CPU) 112, a memory 114, a graphic processing unit (GPU) 115, a storage 116, a server message block (SMB) interface 119, and other required memory, interfaces and Input/Output (I/O) modules (not shown). A hypervisor 118 is stored in the storage 116.

The CPU 112 is a host processor which is configured to control operation of the hypervisor server 110. The CPU 112 can execute the hypervisor 118 or other applications of the hypervisor server 110. In certain embodiments, the hypervisor server 110 may run on more than one CPU as the host processor, such as two CPUs, four CPUs, eight CPUs, or any suitable number of CPUs.

The memory 114 can be a volatile memory, such as the random-access memory (RAM), for storing the data and information during the operation of the hypervisor server 110.

The GPU 115 is a specialized electronic circuit designed to rapidly manipulate and alter the memory 114 to accelerate the creation of images in a frame buffer intended for output to a display. In certain embodiments, the GPU 115 is very efficient at manipulating computer graphics, and the highly parallel structure of the GPU 115 makes it more effective than the general-purpose CPU 112 for algorithms where processing of large blocks of data is done in parallel. Acceleration by the GPU 115 can provide high fidelity and performance enhancements. In certain embodiments, the hypervisor server 110 may have more than one GPU to enhance acceleration.

The storage 116 is a non-volatile data storage media for storing the hypervisor 118 and other applications of the host computer 110. Examples of the storage 116 may include flash memory, memory cards, USB drives, hard drives, floppy disks, optical drives, or any other types of data storage devices.

The hypervisor 118 is a program that allows multiple VM instances to run simultaneously and share a single hardware host, such as the hypervisor server 110. The hypervisor 118, when executed at the CPU 112, implements hardware virtualization techniques and allows one or more operating systems or other applications to run concurrently as guests of one or more virtual machines on the host server (i.e. the hypervisor server 110). For example, a plurality of users, each from one of the thin clients 170, may attempt to run operating systems in the iVDI system 100. The hypervisor 118 allows each user to run an operating system instance as a VM. In certain embodiments, the hypervisor 118 can be of various types and designs, such as MICROSOFT HYPER-V, XEN, VMWARE ESX, or other types of hypervisors suitable for the iVDI system 100.

FIG. 2B schematically depicts the execution of the VM's on the system according to certain embodiments of the present disclosure. As shown in FIG. 2B, when the hypervisor instance 200 runs on the hypervisor server 110, the hypervisor 200 emulates a virtual computer machine, including a virtual CPU 202 and a virtual memory 204. The hypervisor 200 also emulates a plurality of domains, including a privileged domain 210 and an unprivileged domain 220 for the VM. A plurality of VM's 222 can run in the unprivileged domain 220 of the hypervisor 200 as if they are running directly on a physical computer.

It should be noted that the virtual memory 204 may correspond to any memory in the system 100. In other words, the virtual memory 204 may have corresponding physical memory located in any server of the system 100, and the data or information stored in the virtual memory 204 may not be physically stored in the physical memory 114 of the hypervisor server 110. For example, the actual memory storing the data in the virtual memory 204 may exist in the storage server 120, the AD/DHCP/DNS server 130, the management server 140, the broker server 150, the license server 155, or other servers or computers of the system 100.

The SMB interface 119 is an interface for the hypervisor server 110 to perform file sharing with the storage server 120 under the SMB protocol. The SMB protocol is an implementation of a common internet file system (CIFS), which operates as an application-layer network protocol. The SMB protocol is mainly used for providing shared access to files, printers, serial ports, and miscellaneous communications between nodes on a network. Generally, SMB works through a client-server approach, where a client makes specific requests and the server responds accordingly. In certain embodiments, one section of the SMB protocol specifically deals with access to file systems, such that clients may make requests to a file server. In certain embodiments, some other sections of the SMB protocol specialize in inter-process communication (IPC). The IPC share, sometimes referred to as ipc$, is a virtual network share used to facilitate communication between processes and computers over SMB, often to exchange data between computers that have been authenticated. SMB servers make their file systems and other resources available to clients on the network.

In certain embodiments, the hypervisor server 110 and the storage server 120 are connected under the SMB 3.0 protocol. The SMB 3.0 includes a plurality of enhanced functionalities compared to the previous versions, such as the SMB Multichannel function, which allows multiple connections per SMB session, and the SMB Direct Protocol function, which allows SMB over remote direct memory access (RDMA), such that one server may directly access the memory of another computer through SMB without involving either one's operating systems. Thus, the hypervisor server 110 may request for the files or data stored in the storage server 120 via the SMB interface 119 through the SMB protocol. For example, the hypervisor server 110 may request for the VM images and user profiles from the storage server 120 via the SMB interface 119. When the storage server 120 sends the requested VM images and user profiles, the hypervisor server 110 receives the VM images and user profiles via the SMB interface 119 such that the hypervisor 200 can run the VM's 222 in the unprivileged domain 220 as shown in FIG. 2B.

The storage server 120 is a computing device serving as a server for the storage functionality of the system 110. In other words, all storages of the system 100 are available only when the storage server 120 is in operation. In certain embodiments, when the storage server 120 is offline, the system 100 may notify the hypervisor server 110 to stop the hypervisor service until the storage server 120 is back to operation. In certain embodiments, the storage server 110 may be a general purpose computer server system or a headless server.

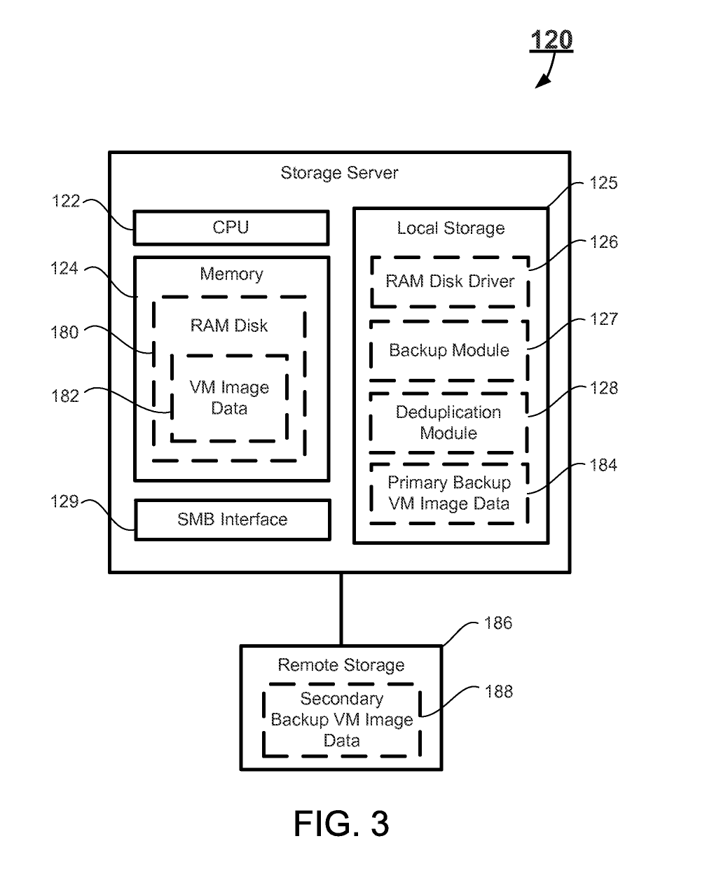

FIG. 3 schematically depicts a storage server according to certain embodiments of the present disclosure. As shown in FIG. 3, the storage server 120 includes a CPU 122, a memory 124, a local storage 125, a SMB interface 129, and other required memory, interfaces and Input/Output (I/O) modules (not shown). Further, a remote storage 186 is connected to the storage server 120. The local storage 125 stores a RAM disk driver 126, a backup module 127, a deduplication module 128, and primary backup VM image data 184. The remote storage 186 stores secondary backup VM image data 184. When the storage server 120 is in operation, a RAM disk 180 is created in the memory 124, and the RAM disk 180 stores VM image data 182.

The CPU 122 is a host processor which is configured to control operation of the storage server 120. The CPU 122 can execute an operating system or other applications of the storage server 120, such as the RAM disk driver 126, the backup module 127, and the deduplication module 128. In certain embodiments, the storage server 120 may run on or more than one CPU as the host processor, such as two CPUs, four CPUs, eight CPUs, or any suitable number of CPUs.

The memory 124 can be a volatile memory, such as the RAM, for storing the data and information during the operation of the storage server 120. When the storage server 120 is powered off, the data or information in the memory 124 will be lost.

In certain embodiments, when the storage server 120 is in operation, the data and information stored in the memory 124 may include a file system, the RAM disk 180, and other data or information necessary for the operation of the storage server 120.

In certain embodiments, the storage server 120 may access to any available memory of the system 100, which is not limited to the memory 124 physically located at the storage server 120. As discussed above, the iVDI system 100 includes the hypervisor server 110 as the host server, and when the hypervisor server 110 launches the hypervisor, the hypervisor 200 emulates a virtual computer machine, including the virtual CPU 202 and the virtual memory 204. The virtual memory 204 is available for the system 100, and may have corresponding physical memory located in any server of the system 100. Thus, the system 100 may use the virtual memory 204 as the memory for storing the file system and the RAM disk 180, and the actual memory storing the RAM disk 180 may include the memory 114 of the hypervisor server 110, the memory 124 of the storage server 120, or any other memory physically located in any other servers or computers of the system 100.

The RAM disk 180, sometimes referred to as a RAM drive, is a memory-emulated virtualized storage for storing the VM image data 182. Data access to the RAM disk 180 is generally 50-100 times faster than data access to a physical non-volatile storage, such as a hard drive. Thus, using the RAM disk 180 as the storage for the VM image data 182 allows the data access to the VM images to speed up, which reduces the bootstorm problem for the VDI service. However, the RAM disk 180 is emulated using volatile memory, and the risk exists that the data or information in the RAM disk 180 may be lost due to power shortage or other reasons.

In certain embodiments, the RAM disk 180 is created by executing the RAM disk driver 126, which allocates a block of the memory of the system (e.g., the virtual memory 204) as if the memory block were a physical storage. In other words, the RAM disk 180 is formed by emulating a virtual storage using the block of the memory of the system. The storage emulated by the RAM disk 180 can be any storage, such as memory cards, USB drives, hard drives, floppy disks, optical drives, or any other types of data storage devices.

The VM image data 182 is a data collection of a plurality of VM images stored in the RAM disk 180. In certain embodiments, each VM image corresponds to a user of the system 100, and may include a user profile.

In certain embodiments, some or all of the VM images in the VM image data 182 are deduplicated. Deduplication is a specialized data compression process for eliminating duplicate copies of repeating data. In the deduplication process, unique data chunks, or byte patterns, of the VM images are identified and stored during a process of analysis. As the analysis continues, other data chunks are compared to the stored copy and whenever a match occurs, the repeat and redundant data chunk is replaced with a small reference that points to the stored data chunk. If no repeat data chunk is identified, the VM image cannot be deduplicated. Generally, given that the same byte pattern may occur dozens, hundreds, or even thousands of times (the match frequency is dependent on the chunk size), the amount of data that must be stored in the VM image data 182 can be greatly reduced.

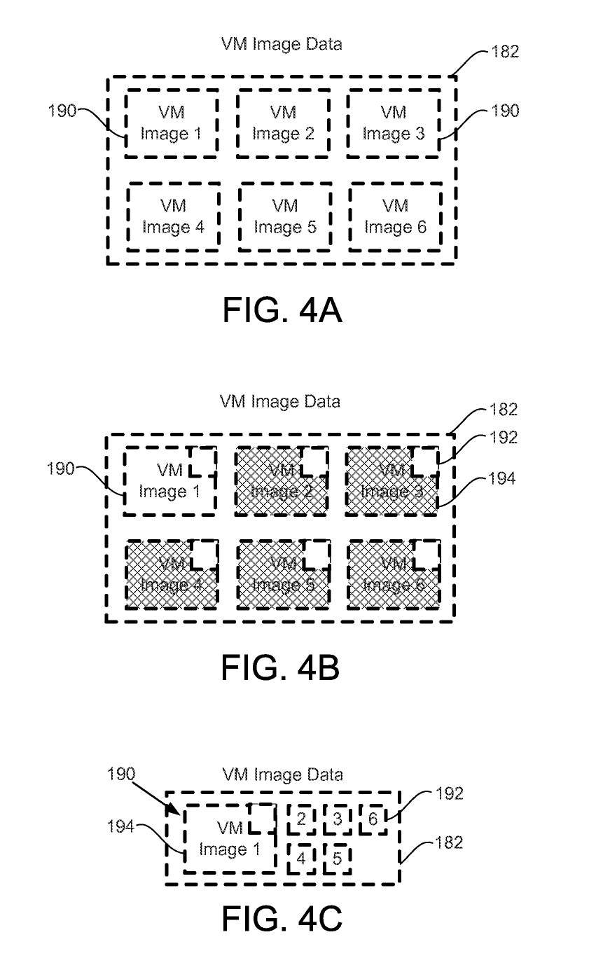

FIGS. 4A to 4C schematically depict an example of the duplication of the VM image data according to certain embodiments of the present disclosure. As shown in FIG. 4A, the VM image data 182 includes a plurality of VM images 190 (respectively labeled VM images 1-6). In certain embodiments, each VM image 190 can be an operating system image for a user of the system 100. Since each user may have a different user profile, each VM image 190 includes the user profile data, which is different from the user profile data of other VM images 190. The rest of the data chunks of the VM images 190 can include the same data, which is repeated over and over again in the VM images 190.

As shown in FIG. 4A, before the deduplication process, each VM image 190 is an uncompressed image, and the size of the VM image data 182 can be large due to the existence of all VM images 190. When deduplication starts, the VM images 190 are identified and analyzed in comparison with each other. For example, each of the VM images 2-6 will be compared with a reference VM image 190 (e.g., the VM image 1). As shown in FIG. 4B, the unique data chunks 192 and other repeat and redundant data chunks 194 for each VM image 190 will be identified such that the repeat and redundant data chunks 194 can be replaced with a reference, such as a pointer, that points to the stored chunk of the reference VM image 1. Once the deduplication analysis is complete, the repeat and redundant data chunks 194 can be removed to release the memory space of the RAM disk 180 occupied by the repeat and redundant data chunks 194. As shown in FIG. 4C, the VM image data 182 after deduplication includes only one full reference VM image (the VM image 1) 190, which includes both the unique data chunks 192 and the repeat data chunks 194, and five unique data chunks or fragments of VM images (2-6) 192. Thus, the size of the VM image data 182 can be greatly reduced, allowing the RAM disk 180 to store additional VM images 190 with further deduplication processes.

In certain embodiments, the deduplicating process is performed recursively in a small pool of the VM images 190 until the maximum limit of the VM images 190 to be stored in the RAM disk 180 is reached.

The local storage 125 is a non-volatile data storage media directly attached to the storage server 120 for storing applications, data and information of the system 110, such as the RAM disk driver 126, the backup module 127, the deduplication module 128, and the primary backup VM image data 184. Examples of the local storage 125 may include flash memory, memory cards, USB drives, hard drives, floppy disks, optical drives, or any other types of data storage devices. Since the local storage 125 is non-volatile, the data stored in the local storage 125 will not be lost when the storage server 120 is powered off.

The RAM disk driver 126 is a software program that emulates the operation and controls the RAM disk 180. The RAM disk driver 126 includes functionalities for creating and accessing the RAM disk 180 in the memory (the virtual memory 204), and configuration settings of the RAM disk 180. In certain embodiments, the functions for creating the RAM disk 180 includes allocating a block of the memory for the RAM disk 180, setting up the RAM disk 180 according to the configuration settings, mounting the RAM disk 180 to the storage server 120, and assigning backup storages for the RAM disk 180. The configuration settings of the RAM disk 180 include the storage type and partition type of the RAM disk 180, the size of the RAM disk 180, and information of the assigned backup storages for the RAM disk 180. In certain embodiments, the RAM disk driver 126 is configured to assign the local storage 125 as a primary backup storage for the RAM disk 180, and to assign the remote storage 186 as a secondary backup storage for the RAM disk 180.

The backup module 127 is a software program that performs the backup actions for the VM image data 182 stored in the RAM disk 180. In certain embodiments, the backup module 127 runs in the background for providing the backup actions on a continuing basis. In other words, the backup actions of the backup module 127 do not interrupt the general operations of the system 100.

As discussed above, when the RAM disk 180 is created, the local storage 125 is assigned as the primary backup storage for the RAM disk 180, and the remote storage 186 is assigned as the secondary backup storage for the RAM disk 180. When the VM image data 182 in the RAM disk 180 is created, the backup module 127 copies the VM image data 182 to the local storage 125 to generate the primary backup VM image data 184 as a primary backup copy of the VM image data 182, and copies the VM image data 182 to the remote storage 186 to generate the secondary backup VM image data 188 as a secondary backup copy of the VM image data 182. In certain embodiments, when the system 100 restarts and the RAM disk 180 is re-mounted, the backup module 127 may copy the primary backup VM image data 184 back to the RAM disk 180 to restore the VM image data 182.

In certain embodiments, the backup module 127 can be configured to automatically perform scheduled backup sessions for the VM image data 182 periodically. In certain embodiments, a user may manually control the backup module 127 to perform the backup actions to the VM image data 182 during the operation of the system 100.

The deduplication module 128 is a software program that performs the deduplication processes for the VM image data 182 stored in the RAM disk 180. An example of the deduplication process is described as above with reference to FIGS. 4A-4C. In certain embodiments, the deduplication module 128 runs in the background for providing the deduplication processes on a continuing basis. In other words, the deduplication processes of the deduplication module 128 do not interrupt the general operations of the system 100.

During the process of deploying the VM image data 182 to the RAM disk 180, the deduplication module 128 performs deduplication to the VM images 190 of the VM image data 182, as shown in FIGS. 4A-4C, such that the size of the VM image data 182 is reduced, allowing the RAM disk 180 to store more VM images. In certain embodiments, the deduplication of the VM images may achieve the compression rate to the order of 70-90%. For example, in a RAM disk 180 which has the memory space of 100 megabytes, the RAM disk 180 may store at most ten uncompressed VM images 190 without deduplication when each VM image 190 may include about 10 megabytes of data. In comparison, the deduplication process allows the RAM disk 180 to store 30-50 VM images.

In certain embodiments, the deduplication module 128 can be configured to deduplicate the VM image data 182 stored in the RAM disk 180, and other data stored in other storages of the system. For example, the deduplication module 128 can be configured to deduplicate the primary backup VM image data 184 stored in the local storage 125 of the storage server 120.

In certain embodiments, the deduplication module 128 can be configured to automatically perform scheduled deduplication sessions for the VM image data 182 stored in the RAM disk 180 periodically. In certain embodiments, a user may manually control the deduplication module 128 to perform the deduplication process to the VM image data 182 during the operation of the system 100.

The primary backup VM image data 184 is a primary copy of the VM image data 182 stored in the local storage 125. As discussed above, the RAM disk 180 is emulated using volatile memory, and the risk exists that VM image data 182 or any other data or information stored in the RAM disk 180 may be lost due to power shortage or other reasons. Thus, the system 100 may maintain a copy of the VM image data 182 in the non-volatile local storage 125 as the primary backup VM image data 184. Thus, when the data in the RAM disk 180 is lost due to power shortage or other reasons, the primary backup VM image data 184 may be used to recover the VM image data 182 in the RAM disk 180.

In certain embodiments, when the VM image data 182 in the RAM disk 180 is created, the system 100 copies the VM image data 182 to the local storage 125 to generate the primary backup VM image data 184 as a primary backup copy of the VM image data 182. In certain embodiments, whenever the system 100 writes or changes data in one of the VM images, the system 100 concurrently writes or changes the corresponding data in the VM image data 182 and the primary backup VM image data 184 to keep the primary backup VM image data 184 synchronized with the VM image data 182 in the RAM disk 180. In other words, the primary backup VM image data 184 is always an exact copy of the VM image data 182 in the RAM disk 180. When the system 100 restarts and the RAM disk 180 is re-mounted, the backup module 127 may copy the primary backup VM image data 184 back to the RAM disk 180 to re-create the VM image data 182.

The SMB interface 129 is an interface for the storage server 120 to perform file sharing with the hypervisor server 110 under the SMB protocol. As discussed above, in certain embodiments, the hypervisor server 110 and the storage server 120 are connected under the SMB 3.0 protocol. Thus, the storage server 120 may receive requests from the hypervisor server 110 via the SMB interface 129 for the files or data stored in the storage server 120, and returns the files or data request to the hypervisor server 110. For example, the hypervisor server 110 may request for the VM images and user profiles from the storage server 120. When the storage server 120 receives the request via the SMB interface 129, the storage server 120 retrieves the requested VM images and user profiles from the RAM disk 180, and sends the retrieved VM images and user profiles back to the hypervisor server 110.

The SMB protocol is an implementation of a common internet file system (CIFS), which operates as an application-layer network protocol. The SMB protocol is mainly used for providing shared access to files, printers, serial ports, and miscellaneous communications between nodes on a network. Generally, SMB works through a client-server approach, where a client makes specific requests and the server responds accordingly. In certain embodiments, one section of the SMB protocol specifically deals with access to file systems, such that clients may make requests to a file server. In certain embodiments, some other sections of the SMB protocol specialize in inter-process communication (IPC). The IPC share, sometimes referred to as ipc$, is a virtual network share used to facilitate communication between processes and computers over SMB, often to exchange data between computers that have been authenticated. SMB servers make their file systems and other resources available to clients on the network.

The remote storage 186 is a non-volatile data storage media, which is not physically located at the storage server 120, for storing the OS (not shown) and other applications of the storage server 120, such as the secondary backup VM image data 188. In certain embodiments, the remote storage 186 can be a storage located at one of the servers in the system 100. For example, the remote storage 186 can be the storage 116 physically located at the hypervisor server 110, or a storage located at the AD/DHCP/DNS server 130, the management server 140, the broker server 150, the license server 155, or other servers or computers of the system 100. Examples of the remote storage 186 may include flash memory, memory cards, USB drives, hard drives, floppy disks, optical drives, or any other types of data storage devices. Since the remote storage 186 is non-volatile, the data stored in the remote storage 186 will not be lost due to power shortage.

In certain embodiments, at least one the RAM disk driver 126, the backup module 127 and the deduplication module 128 may be stored in the remote storage 186 instead of the local storage 125.

The secondary backup VM image data 188 is a secondary copy of the VM image data 182 stored in the remote storage 186. As discussed above, the RAM disk 180 is emulated using volatile memory, and the risk exists that VM image data 182 or any other data or information stored in the RAM disk 180 may be lost due to power shortage or other reasons. Thus, the system 100 may maintain a secondary copy of the VM image data 182 in the non-volatile remote storage 186 as the secondary backup VM image data 188. Since the remote storage 186 is separate from the storage server 120, the secondary backup VM image data 188 provides further insurance for the VM image data 182 in case that errors occur at the storage server 120. If the primary backup VM image data 184 stored in the local storage 125 of the storage server 120 is lost due to any reasons, the secondary backup VM image data 188 may be used to recover the primary backup VM image data 184 stored in the local storage 125 and/or the VM image data 182 in the RAM disk 180.

In certain embodiments, when the VM image data 182 in the RAM disk 180 is created, the system 100 copies the VM image data 182 to the remote storage 186 to generate the secondary backup VM image data 188 as a secondary backup copy of the VM image data 182. In certain embodiments, when the system 100 writes or changes data in one of the VM images, the system 100 does not concurrently update the data in the secondary backup VM image data 188. In other words, the secondary backup VM image data 188 may not be always synchronized with the VM image data 182 in the RAM disk 180. In certain embodiments, when the system 100 writes or changes data in one of the VM images, the system 100 also concurrently update the data in the secondary backup VM image data 188. In other words, both the primary backup VM image data 184 and the secondary backup VM image data 188 will always be synchronized with the VM image data 182 in the RAM disk 180.

The AD/DHCP/DNS server 130 is a server providing multiple services, including the active directory (AD) service, the DHCP service, and the domain name service for the system 100. In certain embodiments, the AD/DHCP/DNS services are provided in one single AD/DHCP/DNS server. In certain embodiments, each of the services may be respectively provided in separate servers.

The AD service is a directory service implemented by Microsoft for Windows domain networks, and is included in most Windows Server operating systems. In certain embodiments, the AD service provides centralized management by authenticating and authorizing all users and computers in the system 100, assigning and enforcing security policies for all computers and installing or updating software. For example, when a user logs into a computer in the system 100 from one of the thin clients 170, the AD service checks the submitted password by the user, and determines whether the user is a system administrator or a normal user of the system 100.

DHCP is a network protocol used to configure devices that are connected to a network so the configured devices can communicate on that network using the Internet Protocol (IP). The protocol is implemented in a client-server model, in which DHCP clients request configuration data, such as an IP address, a default route, and one or more DNS server addresses from the DHCP server. In certain embodiments, the DHCP clients may include the computers in the system 100.

Domain name service is a service hosts a network service for providing responses to queries against a directory service. Generally, the IP address is used to identify and locate computer systems and resources on the Internet. However, an IP address includes a plurality of numeric labels, such as a 32-bit number (known as IP version 4 or IPv4) or a 128-bit number (known as IPv6), which is sometimes difficult for human users to remember. Thus, the domain name service provides a plurality of human-memorable domain names and hostnames as alternative identifications for locating the computer systems and resources on the Internet. When the DNS server receives a query for a domain name or a host name, the domain name service searches for the domain name or hostname, and translates the domain name or hostname into a corresponding numeric IP address of the computer such that the computer is identifiable with the IP address.

The management server 140 is a server providing managing and scheduling aspects for the system 100. In certain embodiments, the management server 140 is in communication with the hypervisor server 110, the storage server 120, and the network 160. In certain embodiments, the management server 140 can run as a service provided on the hypervisor server 110 or the storage server 120.

In certain embodiments, examples of the managing aspects provided by the management server 140 may include hypervisor management, VM management and thin client management. For example, the management server 140 may provide managing service for the hypervisor 200 such as changing the configuration settings for the hypervisor 200, e.g., virtual network switch or the GPU 115 to be used. The management server 140 may also manage actions for the VM's such as creation, deletion and patching as personal or pooled desktops, snapshots configuration, resolution and monitors for each VM, and the virtual CPU 202 and virtual memory 204 used for each VM, etc. The management server 140 may also manage actions for each of the thin clients 170 and providing options for the thin clients 170, such as USB device connectivity, display resolution, network settings, firmware upgrade and VM connection parameters.

In certain embodiments, the management server 140 may also store a copy of the configuration settings of the RAM disk 180. The configuration settings of the RAM disk 180 may include the storage type and partition type of the RAM disk 180, the size of the RAM disk 180, and information of the assigned backup storages for the RAM disk 180.

In certain embodiments, examples of the scheduling aspects provided by the management server 140 may include backup schedule configuration for the backup module 127 and deduplication schedule configuration for the deduplication module 128. In certain embodiments, the schedule configuration may include the time and date information for the scheduled backup or deduplication actions, and the resources (such as CPU or memory resources) to be used by the backup or deduplication actions.

In certain embodiments, the management server 140 also monitors certain events and issues alerts for the system 100. For example, when scheduled backup sessions or deduplication sessions fail, the management server 140 may record the failure of the sessions in a log file and issue a notice to the administrator of the system 100. Other examples of the events monitored may include storage unavailability, RAM disk unavailability or nearing full utilization, CPU resources nearing full utilization, and GPU resource nearing maximum limits, etc.

The failover server 145 is a server providing temporary failover service for the hypervisor server 110 and the storage server 120. The failover service is essentially a redundant or standby service which is activated upon the failure or abnormal termination of the previously active services provided by the hypervisor server 110 and the storage server 120. In certain embodiments, the failover server 145 includes all of the resource elements of the hypervisor server 110 and the storage server 120, but there is no RAM disk driver or GPU available on the failover server 145. In other words, the failover service 145 may serve as a hypervisor server without the GPU, and/or a storage server with only non-volatile storages and no RAM disk available. In certain embodiments, the failover server 145 is in communication with the hypervisor server 110, the storage server 120, and the network 160.

When any service failure occurs in the system 100, the failover server 145 is automatically activated to temporarily take over the failed service for a short term until the failed service becomes available again, allowing the users to continuously access the service at a lower performance in the event of service failure. In certain embodiments, the failover server 145 may detect the availability of the hypervisor server 110 and the storage server 120 by constantly receiving messages from the hypervisor server 110 and the storage server 120. When the hypervisor server 110 or the storage server 120 goes down, the unavailable service will stop sending the message to the failover server 145 such that the failover server 145 may detect the unavailability of the service. For example, when the failover server 145 stops receiving the message from the hypervisor server 110, the failover server 145 determines that the hypervisor server 110 goes down. Upon determining that the hypervisor server 110 goes down, the failover server 145 temporary takes up the role of the hypervisor server 110 without the GPU, and serves the desktops to the users along with the storage server 120 until the hypervisor server 110 restarts. Similarly, when the failover server 145 stops receiving the message from the storage server 120, the failover server 145 determines that the storage server 120 goes down. Thus, the failover server 145 temporary takes up the role of the storage server 120 with only hard disk based storages and no RAM disk until the storage server 120 restarts. In certain embodiments, when both the hypervisor server 110 and the storage server 120 go down, the failover server 145 may take up the multiple roles of the hypervisor server 110 and the storage server 120 at the same time until both the hypervisor server 110 and the storage server 120 are back in operation.

The broker server 150 is a server providing load-balanced user session tracking. In certain embodiments, the broker server 150 includes a broker database, which stores session state information that includes session IDs, their associated user names, and the name of the server where each session resides. When a user with an existing session attempts to connect to the host server (i.e. the hypervisor server 110) of the system 100, the broker server 150 redirects the user to the host server where their session exists. This prevents the user from being connected to a different server in the system 100 and starting a new session.

The license server 155 is a server for providing client access licenses (CALs), which are required for each device or user to connect to the host server (i.e. the hypervisor server 110). In certain embodiments, the system 100 requires at least one license server 155 for managing the CALs for each user or device to connect to the hypervisor server 110 such that the hypervisor server 110 may continue to accept connections from the thin clients 170.

Each of the thin clients 170 is a remote computing device whose operation depends heavily on the servers of the system 100. In certain embodiments, a user may operate from one of the thin clients 170 to remotely connect to the hypervisor server 110, and operates a VM on the hypervisor 200. For example, the user may connect to the hypervisor server 110 from the thin client 170, and launch an operating system as the VM on the hypervisor 200. In certain embodiments, each of the thin clients 170 can be a computing device, such as a general purpose computer, a laptop computer, a mobile device, or any other computer devices or systems.

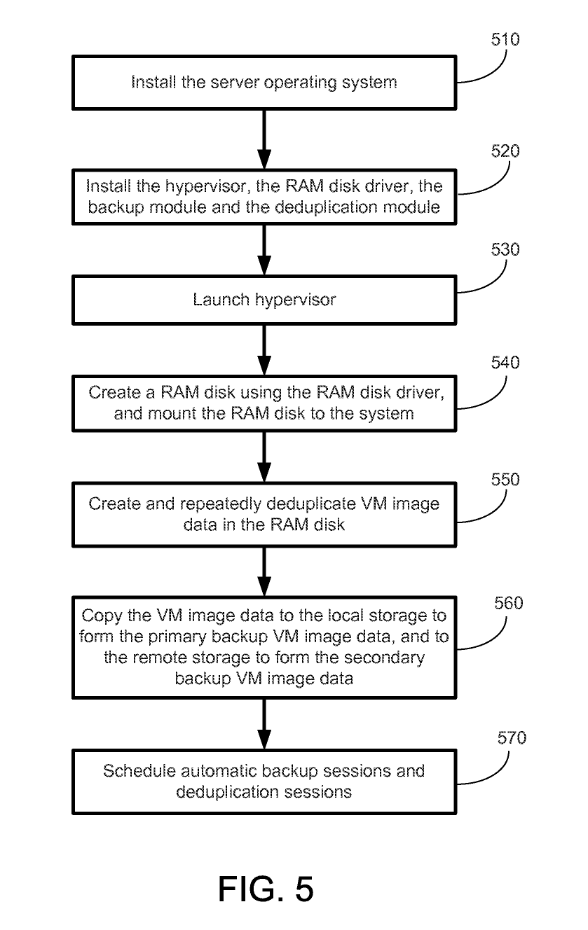

FIG. 5 depicts a flowchart of installing the system and deploying VM images according to certain embodiments of the present disclosure. In certain embodiments, the system 100 can be installed in one or more bare metal computers, which includes no pre-installed operating system or software applications therein. In certain embodiments, the installation process can be performed automatically by an installer software application. In certain embodiments, a user may perform manual installation the system.

At procedure 510, the server operating system is installed to the one or more bare metal computers where the system 100 is to be installed. At procedure 520, the software applications of the system 100, including the hypervisor 118, the RAM disk driver 126, the backup module 127 and the deduplication module 128, are installed in the system 100. After the software applications are installed, at procedure 530, the hypervisor 200 is launched at the hypervisor server 110.

At procedure 540, the hypervisor 200 creates the RAM disk 180 using the RAM disk driver 126, and mounts the RAM disk 180 to the system 100. In certain embodiments, the RAM disk 180 is created at the virtual memory 124, and the physical memory locations of the RAM disk 180 can be separated at different memory of the servers of the system 100. In certain embodiments, the RAM disk driver 126 stores the functions for creating the RAM disk 180 and the configuration settings of the RAM disk 180. The functions for creating the RAM disk 180 includes allocating a block of the memory (the virtual memory 124) for the RAM disk 180, setting up the RAM disk 180 according to the configuration settings, mounting the RAM disk 180 to the storage server 120, and assigning backup storages for the RAM disk 180. The configuration settings of the RAM disk 180 include the storage type and partition type of the RAM disk 180, the size of the RAM disk 180, and information of the assigned backup storages for the RAM disk 180. In certain embodiments, the RAM disk driver 126 is configured to assign the local storage 125 as a primary backup storage for the RAM disk 180, and to assign the remote storage 186 as a secondary backup storage for the RAM disk 180. After the RAM disk 180 is created and mounted, the system 100 treats the RAM disk 180 as if it were a physical storage.

At procedure 550, the hypervisor 200 starts creating and repeatedly deduplicating the VM image data 182 in the RAM disk 180. Specifically, an example of creating and deduplicating the VM images can be explained with reference to FIGS. 4A-4C. For example, a first plurality of VM images 190 (respectively labeled VM images 1-6), each has the size of 10 megabytes, are created in the RAM disk 180, which has the size of 100 megabytes. Each of the first plurality of VM images 190 can be an operating system image for a user of the system 100. Before the deduplication process, each of the first plurality of VM images 190 is an uncompressed image, and the six VM images 190 occupies 60 megabytes in the memory space of the RAM disk 180. When deduplication starts, the deduplication module 128 is loaded and executed to identify and analyze the first plurality of VM images 190 in comparison with each other. For example, each of the VM images 2-6 will be compared with a reference VM image 190 (e.g., the VM image 1). Each of the unique data chunks 192 for each VM image 2-6 has the size of about 1-2 megabytes. Other repeat and redundant data chunks 194 for each VM image 2-6 will be identified and replaced with a pointer, which occupies only a few bytes of memory, that points to the stored chunk of the reference VM image 1. Once the deduplication analysis is complete, the repeat and redundant data chunks 194 for each VM image 2-6 can be removed to release the memory space of the RAM disk 180 occupied by the repeat and redundant data chunks 194. As shown in FIG. 4C, the VM image data 182 after deduplication includes only one full reference VM image (the VM image 1) 190, which includes both the unique chunks 192 and the repeat data chunks 194, and five unique chunks or fragments of VM images (2-6) 192. Thus, the total size of the VM image data 182 becomes about 20 megabytes, which allows another 5-6 second plurality of VM images 190 to be created in the RAM disk 180. After creating the second plurality of VM images 190, further deduplication can be performed. The VM deploying and deduplicating processes repeat until the RAM disk 180 is almost fully occupied by the VM image data 182. In certain embodiments, the RAM disk 180, which has the size of 100 megabytes, can store the VM image data 182 up to more than 90 megabytes, which includes about 30-50 deduplicated VM images.

It should be appreciated that the VM deploying and deduplicating processes are performed recursively. In certain embodiments, deduplication is performed recursively in a small pool of VM images 190 until the maximum limit of the VM images 190 to be stored in the RAM disk 180 is reached.

Once the VM image data 182 is created, at procedure 560, the backup module 127 is loaded and execute to perform the backup actions by copying the VM image data 182 to the local storage 125 to form the primary backup VM image data 184, and to the remote storage 186 to form the secondary backup VM image data 188.

Once the primary and secondary backup copies of the VM image data are created, the system 100 will notify the hypervisor server 110 that the VM images are available. At procedure 570, the backup module 127 and the deduplication module 128 can be configured to set up scheduled automatic backup and deduplication sessions. In certain embodiments, the backup module 127 may perform scheduled automatic backup sessions for the VM image data 182 to the primary backup VM image data 184 and the secondary backup VM image data 188. In certain embodiments, the deduplication module 128 may perform scheduled automatic deduplication sessions for the VM image data 182 and the primary backup VM image data 184. In certain embodiments, the automatic backup and deduplication sessions are respectively performed in the background without interrupting the general operation of the system 100.

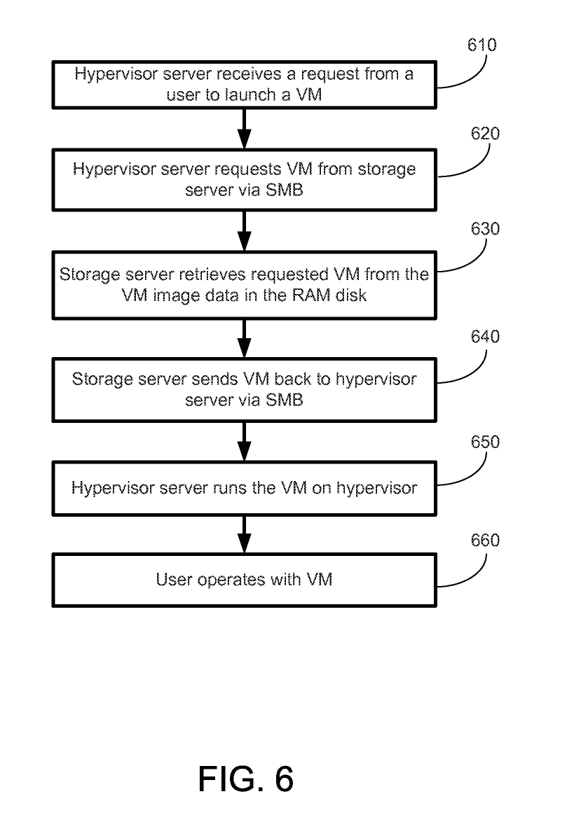

FIG. 6 depicts a flowchart of running a VM on the hypervisor according to certain embodiments of the present disclosure. The VM can be executed on the hypervisor 200 when the hypervisor 200 is launched. In certain embodiments, the VM can be executed on the hypervisor 200 directly after the installation of the system 100, or after the restart of the system 100.

At procedure 610, the hypervisor server 110 receives a request from a user at a thin client 170 to launch a VM. In certain embodiments, the VM can be an operating system, or any other application executable on the hypervisor 200. At procedure 620, the hypervisor server 110 sends a request to the storage server 120 via the SMB protocol, requesting for the VM image.

When the storage server 120 receives the request from the hypervisor server 110, at procedure 630, the storage server 120 retrieves the requested VM image from the VM image data 182 stored in the RAM disk 180. In certain embodiments, the requested VM image may include a full reference VM image 190 (such as the VM image 1 as shown in FIG. 4C) or a unique chunk 192 of the VM image (such as the VM images 2-6 as shown in FIG. 4C) with a pointer that points to the stored chunk of the reference VM image 1. When the VM image includes the unique chunk 192 with a pointer, the storage server 120 retrieves the unique chunk 192 and the stored chunk of the reference VM image 1 pointed by the pointer, and combines the chunks to obtain the full VM image.

At procedure 640, the storage server 120 sends the retrieved VM image back to the hypervisor server 110 via the SMB protocol. Once the hypervisor server 110 receives the VM image, at procedure 650, the hypervisor server 110 runs the VM 220 on the hypervisor 200. At procedure 660, the user can then remote operate with the VM 220 from the thin client.

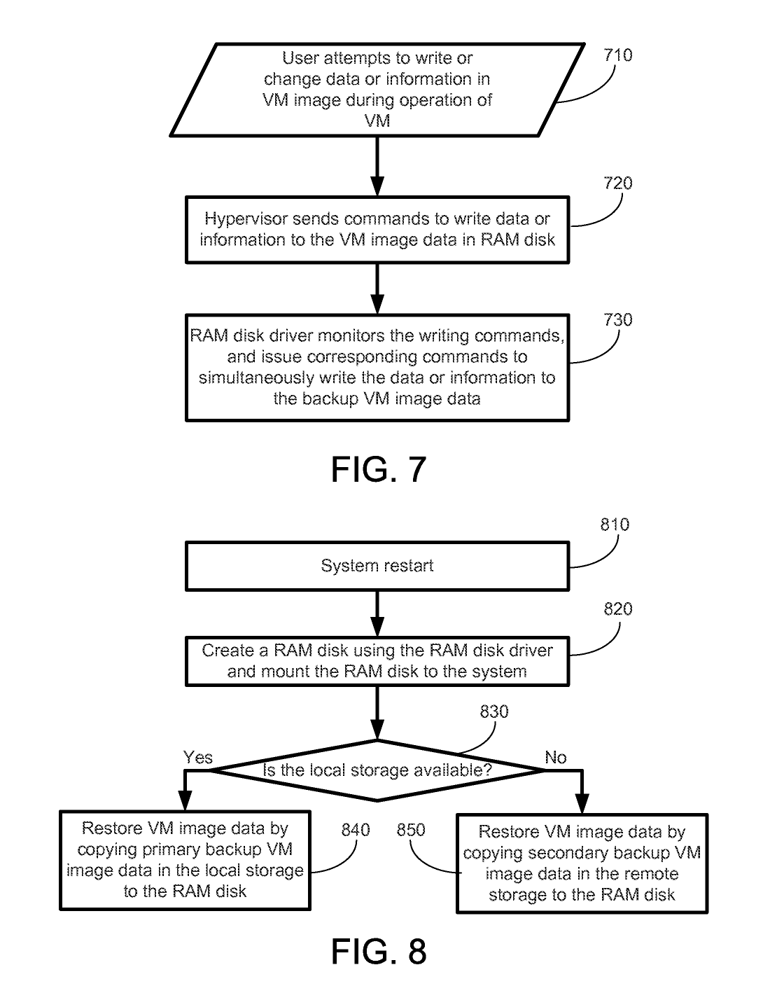

FIG. 7 depicts a flowchart of writing or changing data to a VM image according to certain embodiments of the present disclosure. In certain embodiments, during operation of VM 220, the user may attempt to write or change data or information in the VM image. For example, the user may input a command or execute a software program to change the information in the user profile of the VM image.

At procedure 710, the user attempts to write or change data or information in the VM image during operation of VM 220. When the hypervisor 200 receives the command to write or change data or information in the VM image, at procedure 720, the hypervisor 200 sends commands to write the data or information to the VM image data 182 in the RAM disk 180. At procedure 730, the RAM disk driver 126 monitors the writing commands, and issues corresponding commands to simultaneously write the data or information to the backup VM image data. In certain embodiments, the backup VM image data includes both the primary backup VM image data 184 in the local storage 125 and the secondary backup VM image data 188 in the remote storage 186. Thus, the data or information are written simultaneously to the VM image data 182 in the RAM disk 180, and to both the primary backup VM image data 184 in the local storage 125 and the secondary backup VM image data 188 in the remote storage 186, such that the VM image data 182 in the RAM disk 180, the primary backup VM image data 184 and the secondary backup VM image data 188 are all synchronized. In certain embodiments, only the primary backup VM image data 184 is updated. Thus, the data or information are written simultaneously to the VM image data 182 in the RAM disk 180, and to the primary backup VM image data 184 in the local storage 125, such that the VM image data 182 in the RAM disk 180 and the primary backup VM image data 184 are synchronized.

FIG. 8 depicts a flowchart of restoring the VM image data in the RAM disk when the system restarts according to certain embodiments of the present disclosure. In certain embodiments, the system 100 may automatically restart at scheduled time, or a user may manually restart the system. As discussed above, the RAM disk 180 is emulated using volatile memory. Thus, when the system restarts, there is no data or information in the RAM disk 180, and the VM image data 182 must be restored such that the VM images can be available for the system 100.

At procedure 810, the system restarts. During the restart process, the hypervisor 200 and other necessary application, such as the backup module 127 and the deduplication module 128, are launched.

At procedure 820, the hypervisor 200 creates the RAM disk 180 using the RAM disk driver 126, and automatically mounts the RAM disk 180 to the system 100. The process of creating and mounting the RAM disk 180 is similar to the process 540 as discussed above, and the RAM disk 180 will have the same settings as the RAM disk 180 before the system restarts. After the RAM disk 180 is created and mounted, the system 100 treats the RAM disk 180 as if it were a physical storage.

Once the RAM disk 180 is created and mounted, at procedure 830, the backup module 127 detects if the local storage 125 is available. If the local storage 125 is available, at procedure 840, the backup module 127 restores the VM image data 182 by copying the primary backup VM image data 184 from the local storage 125 to the RAM disk 180. Since the primary backup VM image data 184 is always an exact synchronized copy of the VM image data 182, the VM image data 182 will be the same to the VM image data 182 stored in the RAM disk 180 before the system restarts. If the local storage 125 is not available, at procedure 850, the backup module 127 restores the VM image data 182 by copying the secondary backup VM image data 188 from the remote storage 186 to the RAM disk 180. In certain embodiments, the secondary backup VM image data 188 is also always an exact synchronized copy of the VM image data 182, so the VM image data 182 will be the same to the VM image data 182 stored in the RAM disk 180 before the system restarts.

As discussed above, the system and method as described in the embodiments of the present disclosure use the RAM disk as the storage for the VM image data, and keeps backup VM image data in the physical storages. Comparing to the traditional data access to the physical storage, the use of the RAM disk allows the data access to the VM images to speed up, which reduces the bootstorm problem for the VDI service.

The method as described in the embodiments of the present disclosure can be used in the field of, but not limited to, remote VM operation.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope. Accordingly, the scope of the present disclosure is defined by the appended claims rather than the foregoing description and the exemplary embodiments described therein.

What is claimed is:

1. A method for performing intelligent virtual desktop infrastructure (iVDI) using volatile memory arrays, comprising:
launching a random access memory (RAM) disk on a volatile memory array using a RAM disk driver;
assigning a local storage physically located at a storage server as a primary backup storage for the RAM disk, wherein the storage server is connected to a hypervisor server via a file sharing protocol, and the hypervisor server is configured to execute a hypervisor;
deploying a first plurality of virtual machine (VM) images to the RAM disk;
deduplicating the first plurality of VM images in the RAM disk to release a first memory space of the RAM disk;
deploying a second plurality of VM images to the RAM disk and to occupy at least a part of the first memory space;
deduplicating the second plurality of VM images in the RAM disk; and
copying the deduplicated first plurality of VM images and the deduplicated second plurality of VM images from the RAM disk to the primary backup storage.

2. The method as claimed in claim 1, further comprising:
launching, at the hypervisor server, the hypervisor.

3. The method as claimed in claim 1, further comprising:
in response to an accessing command for a requested VM image from a remote computing device connected to the hypervisor server via a network,
sending a request for the requested VM image from the hypervisor server to the storage server;
retrieving, at the storage server, the requested VM image from the RAM disk;
sending the requested VM image from the storage server to the hypervisor server; and
running, at the hypervisor server, the requested VM image on the hypervisor.

4. The method as claimed in claim 1, further comprising:
in response to a writing command of data to the running VM image, simultaneously writing the data to the running VM image at the RAM disk and at the primary backup storage.

5. The method as claimed in claim 4, wherein the simultaneously writing of the data to the running VM image at the RAM disk and at the primary backup storage comprises:
receiving, by the hypervisor, the writing command;
monitoring, by the RAM disk driver, the writing command;
writing, by the hypervisor, the data to the running VM image at the RAM disk according to the writing command; and
simultaneously writing, by the RAM disk driver, the data to the running VM image at the primary backup storage and at the secondary backup storage according to the writing command.

6. The method as claimed in claim 1, wherein the file sharing protocol is a server message block (SMB) protocol.

7. The method as claimed in claim 1, wherein the deduplicating of the first plurality of VM images and the deduplicating of the second plurality of VM images in the RAM disk are performed by a deduplication module, wherein the deduplication module is configured to, when executed at a processor,
compare the VM images to identify at least one repeat data chunk existing for multiple times in the VM images;
store the at least one repeat data chunk in the RAM disk;
store a reference in the VM image pointing to the at least one repeat data chunk stored in the RAM disk; and
remove the at least one repeat data chunk for the VM images.

8. The method as claimed in claim 7, wherein the deduplication module is configured to, when executed at a processor,
identify a reference VM image from the VM images in the RAM disk;
for each VM image, compare the VM image to the reference VM image to identify the at least one repeat data chunk existing in both the VM image and the reference VM image, and a unique data chunk existing only in the VM image;
store a reference in the VM image pointing to the at least one repeat data chunk of the reference VM image; and
remove the at least one repeat data chunk in the VM image.

9. The method as claimed in claim 7, wherein the deduplication module is further configured to, when executed at a processor, periodically deduplicate the VM images stored in the RAM disk and the VM images stored in the primary backup storage.

10. The method as claimed in claim 1, wherein the copying of the deduplicated VM images from the RAM disk to the primary backup storage is performed by a backup module.

11. The method as claimed in claim 10, further comprising:
assigning a remote storage device not located at the storage server as a secondary backup storage for the RAM disk;
copying, by the backup module, the deduplicated VM images from the RAM disk to the secondary backup storage;
in response to the RAM disk being relaunched and the primary backup storage being available, copying the VM images from the primary backup storage to the RAM disk; and
in response to the RAM disk being relaunched and the primary backup storage being unavailable, copying the VM images from the secondary backup storage to the RAM disk.

12. The method as claimed in claim 10, wherein the backup module is further configured to, when executed at a processor, periodically copying the VM images from the RAM disk to the primary backup storage and the secondary backup storage.

13. The method as claimed in claim 1, wherein the RAM disk driver stores configuration settings of the RAM disk, and wherein the configuration settings of the RAM disk comprises a storage type of the RAM disk, partition type of the RAM disk, size of the RAM disk, and information of the assigned primary backup storage.

14. An intelligent virtual desktop infrastructure (iVDI) system, comprising:
a hypervisor server configured to execute a hypervisor;
a storage server in communication to the hypervisor server via a file sharing protocol, wherein the storage server comprises a local storage physically located at the storage server and a remote storage device not located at the storage server, wherein the storage server stores a random access memory (RAM) disk driver; and
a volatile memory array, comprising volatile memory provided on at least one of the hypervisor server and the storage server;
wherein the RAM disk driver comprises computer executable codes, wherein the codes, when executed on the hypervisor at a processor, are configured to
launch a RAM disk on the volatile memory array using the RAM disk driver;
assign the local storage as a primary backup storage for the RAM disk, and the remote storage as a secondary backup storage for the RAM disk;
deploy a first plurality of virtual machine (VM) images to the RAM disk;
deduplicate the first plurality of VM images in the RAM disk to release a first memory space of the RAM disk;
deploy a second plurality of VM images to the RAM disk and to occupy at least a part of the first memory space;
deduplicate the second plurality of VM images in the RAM disk; and
copy the deduplicated first plurality of VM images and the deduplicated second plurality of VM images from the RAM disk to the primary backup storage.

15. The iVDI system as claimed in claim 14, wherein the file sharing protocol is a server message block (SMB) protocol.

16. The iVDI system as claimed in claim 14, further comprising:
at least one remote computing device in communication to the hypervisor server via a network;
wherein in response to an accessing command for a requested VM image from the remote computing device, the codes, when executed on the hypervisor at the processor, are further configured to
send a request for the requested VM image from the hypervisor server to the storage server;
retrieve the requested VM image from the RAM disk;
send the requested VM image from the storage server to the hypervisor server; and
run the requested VM image on the hypervisor;
wherein in response to a writing command of data to the running VM image from the remote computing device, the codes, when executed on the hypervisor at the processor, are further configured to
receive the writing command;
write the data to the running VM image at the RAM disk according to the writing command; and
simultaneously write the data to the running VM image at the primary backup storage and at the secondary backup storage according to the writing command.

17. The iVDI system as claimed in claim 14, wherein the codes comprise a deduplication module and a backup module,
wherein the deduplication module is configured to
compare the VM images to identify at least one repeat data chunk existing for multiple times in the VM images;
store the at least one repeat data chunk in the RAM disk;
store a reference in the VM image pointing to the at least one repeat data chunk stored in the RAM disk; and
remove the at least one repeat data chunk for the VM images; and wherein the backup module is configured to
copy the deduplicated VM images from the RAM disk to the primary backup storage and the secondary backup storage;
in response to the RAM disk being relaunched and the primary backup storage being available, copy the VM images from the primary backup storage to the RAM disk; and
in response to the RAM disk being relaunched and the primary backup storage being unavailable, copy the VM images from the secondary backup storage to the RAM disk.

18. The iVDI system as claimed in claim 17, wherein the deduplication module is further configured to periodically deduplicate the VM images stored in the RAM disk and the VM images stored in the primary backup storage.

19. The iVDI system as claimed in claim 14, wherein the RAM disk driver further comprises configuration settings of the RAM disk, and wherein the configuration settings of the RAM disk comprises a storage type of the RAM disk, partition type of the RAM disk, size of the RAM disk, and information of the assigned primary backup storage.

20. The iVDI system as claimed in claim 14, further comprising:
a management server in communication with the hypervisor server and the storage server, configured to provide hypervisor management, VM management and thin client management; and
a failover server in communication with the hypervisor server and the storage server, configured to provide failover service in response to at least one of the hypervisor server and the storage server being unavailable.

21. The iVDI system as claimed in claim 20, wherein the management server runs as a service on one of the hypervisor server and the storage server.

22. The iVDI system as claimed in claim 20, wherein the management server is further configured to provide backup schedule configuration and deduplication schedule configuration.

23. The iVDI system as claimed in claim 20, wherein the management server is further configured to store a copy of configuration settings of the RAM disk, and to monitor system events and issue alerts.

24. The iVDI system as claimed in claim 20, wherein the failover service provided by the failover server comprises:
in response to the hypervisor server being unavailable, providing hypervisor service until the hypervisor server becomes available; and
in response to the storage server being unavailable, providing storage service without the RAM disk until the storage server becomes available.

25. A non-transitory computer readable medium storing a RAM disk driver, wherein the RAM disk driver comprises computer executable codes, wherein the codes, when executed at a processor, are configured to:
launch a RAM disk on a volatile memory array using the RAM disk driver;
assign a local storage of a storage server as a primary backup storage for the RAM disk, and a remote storage of the storage server as a secondary backup storage for the RAM disk, wherein the storage server is connected to a hypervisor server via a file sharing protocol, and the hypervisor server is configured to execute a hypervisor;
deploy a first plurality of virtual machine (VM) images to the RAM disk;
deduplicate the first plurality of VM images in the RAM disk to release a first memory space of the RAM disk;
deploy a second plurality of VM images to the RAM disk and to occupy at least a part of the first memory space;
deduplicate the second plurality of VM images in the RAM disk; and
copy the deduplicated first plurality of VM images and the deduplicated second plurality of VM images from the RAM disk to the primary backup storage.

26. The non-transitory computer readable medium as claimed in claim 25, wherein the file sharing protocol is a server message block (SMB) protocol.

27. The non-transitory computer readable medium as claimed in claim 25, wherein
in response to an accessing command for a requested VM image from the remote computing device, the codes are configured to
send a request for the requested VM image from the hypervisor server to the storage server;
retrieve the requested VM image from the RAM disk;
send the requested VM image from the storage server to the hypervisor server; and
run the requested VM image on the hypervisor;
in response to a writing command of data to the running VM image from the remote computing device, the codes are configured to
receive the writing command;
write the data to the running VM image at the RAM disk according to the writing command; and
simultaneously write the data to the running VM image at the primary backup storage and at the secondary backup storage according to the writing command.

28. The non-transitory computer readable medium as claimed in claim 25, wherein the codes comprise a deduplication module and a backup module,
wherein the deduplication module is configured to
compare the VM images to identify at least one repeat data chunk existing for multiple times in the VM images;
store the at least one repeat data chunk in the RAM disk;
store a reference in the VM image pointing to the at least one repeat data chunk stored in the RAM disk; and
remove the at least one repeat data chunk for the VM images; and
wherein the backup module is configured to
copy the deduplicated VM images from the RAM disk to the primary backup storage and the secondary backup storage;
in response to the RAM disk being relaunched and the primary backup storage being available, copy the VM images from the primary backup storage to the RAM disk; and
in response to the RAM disk being relaunched and the primary backup storage being unavailable, copy the VM images from the secondary backup storage to the RAM disk.

29. The non-transitory computer readable medium as claimed in claim 28, wherein the deduplication module is further configured to periodically deduplicate the VM images stored in the RAM disk and the VM images stored in the primary backup storage.

30. The non-transitory computer readable medium as claimed in claim 25, wherein the RAM disk driver comprises configuration settings of the RAM disk, and wherein the configuration settings of the RAM disk comprises a storage type of the RAM disk, partition type of the RAM disk, size of the RAM disk, and information of the assigned primary backup storage.
